(19) United States
(12) Patent Application Publication
(10) Pub. No.: US 2011/0195171 A1
(43) Pub. Date: Aug. 11, 2011

(54) ANTIOXIDANT ADDITIVE

(75) Inventor: David M. Tieman, Rancho Santa Margarita, CA (US)

(73) Assignee: T & T Enterprises Inc., Rancho Santa Margara, CA (US)

(21) Appl. No.: 13/056,457

(22) PCT Filed: Jul. 30, 2009
(86) PCT No.: PCT/US09/52303

§ 371 Date: Jan. 28, 2011

Related U.S. Application Data
(60) Provisional application No. 61/084,888, filed on Jul. 30, 2008.

(51) Int. Cl. A23F 5/14; A23L 1/30

(52) U.S. Cl. 426/595; 366/146; 426/648

(57) ABSTRACT

An antioxidant additive includes one, two, or all three of Matcha, Rooibos and Goji Berry. In a method of making a fused antioxidant additive that includes at least two components, the at least two components are fused together in a fusion process, wherein the at least two components are added to a fusion chamber and stirred together until the volume of the contents of the fusion chamber has decreased by a sufficient amount, thereby indicating that the at least two components have fused to each other. The fused antioxidant additive has unique properties that allow it to be added to coffee beans during roasting. During the coffee roasting process, the fused antioxidant additive is added to the roasting chamber after first crack. Coffee roasted in this manner has an unexpectedly high degree of antioxidant power.

This application claims the benefit of U.S. Provisional Application No. 61/084,888, filed on Jul. 30, 2008, and incorporated herein by reference in its entirety.

### FIELD OF THE INVENTION

The present invention relates to an antioxidant additive, a method for making a fused antioxidant additive, and a method for incorporating the fused antioxidant additive into coffee beans during roasting. More particularly, the present invention relates to an antioxidant additive that can be added to, or incorporated into, beverages, food, topically applied products, etc.

### BACKGROUND OF THE INVENTION

The routine consumption of coffee and coffee-type drinks by millions of people per day is a widely growing trend. However, coffee is generally not known to have many nutritional or health benefits and is primarily consumed for its taste and its caffeine content. Others have recognized this deficiency and attempted various coffee formulations fortified with nutritional additives. For example, in U.S. Pat. No. 6,207,203 there is disclosed a powder composition that provides a low fat vitamin and mineral fortified coffee drink when reconstituted with water, the nutritional composition being in the form of a soluble powder containing an instant coffee component, a protein component, a vitamin/mineral component providing at least 25% of U.S. RDI per 8 ounce serving, and a carbohydrate component in about 140 calories per 8 ounce serving. What is still needed and heretofore not available in the art is a high quality and beneficial coffee or coffee additive without compromising taste, particularly such a beverage additive or resulting beverage that is high in antioxidants. Further, it would be advantageous for such an antioxidant additive to be capable of being incorporated into other beverages, foods, and products that are topically applied.

### SUMMARY OF THE INVENTION

In accordance with a first aspect of the present invention, a powdered, water-soluble and fat-soluble, antioxidant additive is provided. The antioxidant additive includes at least two components selected from the group consisting of: Matcha, Rooibos, and Goji Berry. The at least two components are fused to one another, and a heat stability of the additive is such that the additive is capable of being incorporated into coffee beans during a roasting process.

In accordance with a second aspect of the present invention, a method for making a fused antioxidant additive is provided. The method includes adding at least two powdered components to a fusion chamber. The at least two powdered components are selected from the group consisting of Matcha, Rooibos, and Goji Berry. The fusion chamber includes an inner lining, rotatable paddles, and sleeves covering the paddles. A material of the inner lining and a material of the paddle sleeves are on opposite ends of a triboelectric series. The method also includes rotating the paddles in the fusion chamber and verifying that the at least two powdered components have transformed into the fused antioxidant additive.

In accordance with a third aspect of the present invention, an antioxidant additive is provided that includes at least two components selected from the group consisting of: Matcha, Rooibos, and Goji Berry. The at least two components may be subjected to a fusion process, such that the additive may be a fused additive. The additive may be a water-soluble and fat-soluble powder. A heat stability of the additive may be such that the additive is capable of being incorporated into coffee beans during a roasting process. The additive may be stable at temperatures between about 300 and 450 degrees Fahrenheit, and even between temperatures between about 30 and 450 degrees Fahrenheit. In one embodiment, the additive includes Matcha, Rooibos and Goji Berry. In another embodiment, the additive consists of Matcha and Rooibos.

The additive may further include another component selected from the group consisting of: açai (Euterpe oleracea), blueberry (Vaccinium angustifolium and Vaccinium corymbosum), cranberry (Vaccinium macrocarpon), grape (red, Vitis vinifera), guarana (Paullinia cupana), mangosteen (Garcinia mangostana), noni (Morinda citrifolia), pomegranate (Punica granatum), sea-buckthorn (Hippophae rhamnoides), strawberries (Fragaria vesca), red raspberries (Rubus idaeus), blackberries (Rubus ursinus), acerola (Barbados cherry, Malpighia emarginata, Malpighia glabra), baobab (Adansonia digitata), red bayberry (yumberry, Myrica rubra), bilberry (Vaccinium myrtillus), black raspberry (Rubus occidentalis), black chokeberry (“aronia”, Aronia melanocarpa), black currant (Ribes nigrum), camu camu (Myrciaria dubia), sour (tart) cherry (Prunus cerasus), cupuaçu (Theobroma grandiflorum), durian (Durio kutejensis), elderberry (Sambucus canadensis, Sambucus nigra), red guava (Psidium guajava, many species), Indian gooseberry (amalaka, amla, Phyllanthus emblica), kiwifruit (Actinidia deliciosa), lingonberry (Vaccinium vitis-idaea), longan (Dimocarpus longan), lychee (Litchi chinensis), mango (Mangifera indica), muscadine grape (Vitis rotundifolia), papaya (Carica papaya), saskatoon berry (Amelanchier alnifolia, Nutt), tamarind (Tamarindus indica), wild cherry (sweet, Prunus avium), yuzu (Citrus ichangensis x C. reticulata), chia seed (Salvia hispanica), rambutan (Nephelium lappaceum), cacao, (Theobroma cacao), coffee berry raw (Coffea arabica), bee Pollen, aloe vera (A. barbadensis Mill., Aloe indica Royle, Aloe perfoliata L. var. vera and A. vulgaris Lam), yacon root (Smallanthus sonchifolius), synonyms (Polymnia sonchifolia), maca (Lepidium meyenii), Rose hips (Rosa canina, Dog Rose, and R. majalis), watercress (Nasturtium officinale, N. microphyllum; formerly Rorippa nasturtium-aquaticum, R. microphylla), papaya (Carica papaya), soy (Glycine max), flax seed (Linum usitatissimum), oranges citrus sinensis (syn. Citrus aurantium L. var. dulcis L., or Citrus aurantium Risso), walnuts (family Juglandaceae all) (Genus Juglans), honey, quinoa (Chenopodium quinoa), hazel nuts (Corylus avellana), vanilla bean (Vanilla planifolia, V. planifolia, syn. V. fragrans, V. tahitensis, and V. pompona), caramel, butterscotch, apple (Malus domestica), sceletium tortuosum (Kanna), water avens (Geum rivale), cleavers goose grass (Gallium Aparine), scotch broom (Cytisus scoparius), common sunflower (Helianthus annuus), chufa (Cyperus esculentus), beech (Fagus grandifolia), kentucky coffee tree (Gymnocladus dioica), feverwort (Triosteum perfoliatum), and yaupon, cassina (Ilex vomitoria).

In accordance with a fourth aspect of the present invention, a method for making a fused additive is provided. The method includes adding at least two powdered components to a fusion chamber. The fusion chamber includes an inner lining, rotatable paddles, and sleeves covering the paddles. A material of the inner lining and a material of the paddle sleeves are on opposite ends of a triboelectric series. The method also includes rotating the paddles in the fusion chamber until a volume of the contents of the fusion chamber has decreased by a selected amount. In one embodiment, the at least two powdered components include Matcha and Rooibos. In another embodiment, the at least two powdered components comprise Matcha, Rooibos, and Goji Berry. The paddles may be rotated at a rate of between about 900 and 1100 RPMs.

In accordance with a fifth aspect of the present invention, a method for fusing an additive to coffee beans during roasting is provided. The method includes adding raw coffee beans to a pre-heated roasting chamber; roasting the coffee beans until first crack; after first crack, adding the additive to the roasting chamber; and roasting the coffee beans until the additive is incorporated into the coffee beans, and a desired roast depth is achieved. The method may also include pre-treating the raw coffee beans with the additive. Before adding the additive to the roasting chamber, the method may further include making the additive using a fusion process. The additive may include Matcha and Rooibos. The Matcha and Rooibos may be fused together such that the additive comprises a fused additive. The additive may further include Goji Berry.

Other and further aspects and features of the invention will be evident from reading the following detailed description of the preferred embodiments, which are intended to illustrate, not limit, the invention.

### BRIEF DESCRIPTION OF THE DRAWINGS

The drawings illustrate the design and utility of preferred embodiments of the present invention, in which similar elements are referred to by common reference numerals. In order to better appreciate how the above-recited and other advantages and objects of the present invention are obtained, a more particular description of the present invention briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1A is a cross-sectional view in a plane that includes a central axis of a fusion chamber used in accordance with an embodiment of the present invention;

FIG. 1B is a cross-sectional view perpendicular to the central axis of the fusion chamber depicted in FIG. 1A;

FIG. 2A is a cross-sectional view in a plane that includes a central axis of a roasting chamber used in accordance with an embodiment of the present invention;

FIG. 2B is a cross-sectional view of the roasting chamber taken along line 2B-2B in FIG. 2A;

FIG. 3 is a flow chart of a roasting process in accordance with an embodiment of the present invention; and

FIG. 4 is a flow chart of a method for adding an additive to coffee, in accordance with an embodiment of the present invention.

### DETAILED DESCRIPTION OF THE EMBODIMENTS

The subject of this patent application is generally directed to an antioxidant additive. As an exemplary embodiment of the present invention, various combinations of one, two, or all three of Matcha, Rooibos and Goji Berry may be employed as a substantially flavor-neutral, healthy, relatively high antioxidant additive that can be combined with beverages, food, or topically applied products, such as cosmetics, moisturizers, body washes, shampoos, sun blocks, spray tan formulations, and the like.

Aspects of the present invention are directed to an antioxidant additive comprising Matcha, Rooibos, Goji Berry, and combinations thereof, that, when combined with a product, infuses the product with a relatively high amount of antioxidants, known in the art to terminate molecular oxidation reactions in the body by removing free radical intermediates, and thereby providing a number of health benefits related to the prevention of disease and aging. Antioxidants are often reducing agents like thiols or polyphenols, and are typically found in natural, whole foods such as fruits and berries, nuts, and grasses. It has been recently discovered that Matcha and Rooibos are very high in certain naturally-occurring antioxidants. Those skilled in the art will appreciate that, while the foregoing general discussion and the more detailed discussion that follows are directed to particular combinations of Matcha, Rooibos, and/or Goji Berry, the invention is not so limited, such that numerous other formulations are possible without departing from the spirit and scope of the invention.

In more detail, first, regarding Matcha, Matcha is the common name for a powdered, high-grade green tea made from the raw, whole tea leaf, the entire green tea leaf typically being ground to a fine powder. Botanically, Matcha derives from various species of Camellia, a genus of flowering plants in the family Theaceae native to eastern and southern Asia from the Himalayas east to Japan and Indonesia. Currently, there are roughly 100-250 existent Camellia species, with some controversy over the exact number. In exemplary embodiments of the present invention, the species of Matcha employed is Camellia sinensis, though it will be appreciated that any and all Camellia (Matcha) species in any form, both now known and later discovered, may be employed in the present invention, including, but not limited to, Camellia taliensis. Matcha advantageously includes a number of antioxidants or “catechins,” some of the most powerful natural antioxidants known, thereby having strong anti-disease and anti-aging effects on the body. Catechins are polyphenolic antioxidant plant metabolites belonging to the family of flavonoids and, to be more specific, flavan-3-ols. Catechins constitute about 25% of the dry weight of fresh tea leaf, although total catechin content varies widely depending on clonal variation, growing location, seasonal/light variation, and altitude. They are particularly present and abundant in nearly all teas made from Camellia sinensis. The catechins found in green tea are 100 times stronger than Vitamin C and 25 times stronger than Vitamin E. As a result, for comparison, Matcha contains 70 times the antioxidant capacity of orange juice. Matcha also contains: Theanine or L-theanine, the main free amino acid component of tea that also has favorable physiological effects related to increasing alpha waves in the brain; Theophylline, a unique form of caffeine found only in tea, particularly green tea, that releases very slowly, over 8-10 hours, thus providing sustained energy without the negative effects of caffeine; Chlorophyll in high levels, one of the most powerful blood detoxifiers, which supports a healthy blood alkalinity; and Polysaccharides that protect against insulin spikes, thus stabilizing blood sugar levels. In addition, Matcha 's core chemistry includes cholesterol lowering agents and anti-microbials (anti-biotics and anti-virals). As a result, Matcha acts to fight disease through its anti-microbial, anti-cancer, anti-diabetes, and anti-HIV properties, boosts the immune system and mental alertness, increases metabolic rate and so acts as a weight loss aid, lowers stress hormone levels, and even reduces risk of cognitive impairment (anti-aging effect).

It has been suggested that Matcha has greater potential health benefits than other green teas. For example, Matcha has 137 times the amount of EGCG found in regular brewed green tea. Matcha is the strongest known form of green tea, and as such, it imparts all of the health benefits of green tea in a super-concentrated form, and thus has hundreds of times more nutrients than regular brewed, steeped, bagged, loose or bulk green teas. Matcha imparts a tremendous dose of all the important health-promoting constituents contained in green tea, plus hundreds of times more nutrients that come from ingesting the entire tea leaf. Drinking one cup of Matcha powdered green tea is the equivalent to drinking over 100 cups of regular green tea in ORAC value. In particular, the ORAC value of brewed, steeped, bagged, loose, or bulk leaf green tea is 12.53 per 1 gram, while the ORAC value of Matcha is 1,384 per 1 gram. However, those skilled in the art will appreciate that Matcha or any other form of green tea or any active ingredient or ingredients found in green tea, including but not limited to those cited above, may be employed in various combinations within an antioxidant additive according to aspects of the present invention.

Turning now to Rooibos, many of the same physiological advantages as indicated above for Matcha also derive from this all-natural herb. The botanical name for Rooibos is Aspalathus linearis, a broom-like member of the legume family of plants that is grown primarily in the Cederberg region of the Western Cape province of South Africa and is traditionally used to make an herbal tea. Rooibos is commonly called South African red tea or simply red tea or bush tea due to the distinctive reddish-brown color of Rooibos that has been “fermented,” a process by which the leaves are oxidized or are slightly crushed to open the inside of the leaves to fermentation. By comparison, green Rooibos is not crushed and so is effectively unfermented, whereby the tea leaves remain richer in antioxidants. In the present invention, red Rooibos, green Rooibos, or any other variety of Rooibos now known or later developed or discovered may be used, though green Rooibos extract is preferable. Rooibos generally is rich in polyphenols, including flavonoids and phenolic acids that are again potent free radical scavengers (antioxidants), such flavonoids including dihydrochalcone aspalthin, rutin, and orientin. Rooibos is also a rare source of dietary dihydrochalcones, aspalathin, and nothofagin and has demonstrated potent antioxidant, immune-modulating and chemopreventive actions when ingested. Finally, Rooibos contains zero caffeine and is low in tannin, tannins being involved in the binding of calcium and iron that makes it difficult for the body to absorb these minerals, two additional advantages of Rooibos tea. As with Matcha, it will be appreciated by those skilled in the art that red or green Rooibos or any other form of Rooibos or any active ingredient or ingredients found in Rooibos, including but not limited to those cited above, may be employed in various combinations within an antioxidant additive according to aspects of the present invention without departing from its spirit and scope.

Another antioxidant, Goji Berry, has been shown to have effectiveness or benefits in the areas of cancer prevention, cancer treatment, inhibition of tumor growth, reduction of the toxic effects of chemotherapy and radiation, DNA restoration and repair (preventing mutations that can cause cancer), improvement in immune response (T-cell, IL-2, IgA, IgG), treatment of bone marrow deficiency by stimulating red and white blood cells, improvement in lymphocyte count, activation of anti-inflammatory enzymes, inhibition of lipid peroxidation (a cause of heart disease), treatment of weakened digestion system, treatment of Alzheimer's disease, and metabolism and weight regulation. The botanical name for Goji Berry is Lycium Barbarum or Lycium Barbarum polysaccharide (LBP), though Goji Berries are also called Wolf Berries. Goji Berries in the form of freeze dried or dried whole Goji Berries, Goji Berry powder, Goji juice, or any other form now known or later developed may be employed in the antioxidant additive according to aspects of the present invention without departing from its spirit and scope.

The antioxidant additive of the present invention may include one, two, or all three of the above-listed components (Matcha, Rooibos, and Goji Berry). The additive may be combined with a hot or cold beverage as the raw materials of the beverage are produced or formulated, when the beverage is made, or at any time thereafter, before being consumed. It will be appreciated by those skilled in the art that while a number of exemplary embodiments of the base beverages and the corresponding beverage additives and adjuncts are described herein, the invention is not so limited. Rather, a virtually infinite variety of combinations of Matcha, Rooibos, and/or Goji Berry, alone or in combination with other adjuncts, may be employed in a beverage additive according to aspects of the present invention without departing from its spirit and scope.

In the context of coffee beverages, the antioxidant additive may be added to coffee at the post-roast blending stage, whether whole bean or ground, or even after the coffee is brewed just as one would add cream or sugar. Depending on various beverage production processes, now known or later developed, the Matcha, Rooibos, and Goji Berry ingredients can be combined alone or together with base coffees and other base ingredients to produce a variety of hot and cold beverages, including but not limited to various coffee blends, “black teas,” and instant iced teas, as explained in further detail below. Some examples of the present invention are directed to the combination of one, two or all three of Matcha, Rooibos, and Goji Berry, essentially with whole, ground, or brewed coffee to produce a beverage with a rich, complex flavor while providing an ultra-high serving of antioxidants inherent in the Matcha, Rooibos, and Goji Berry.

### Example 1

In a first exemplary formulation of a beverage or beverage additive according to aspects of the present invention, coffee and Matcha are combined by weight ratio according to the following approximate amounts: 12 ounces of coffee and 3.0 grams of Matcha. It is noted that this formulation is representative of how or in what proportion the exemplary components of the beverage or beverage additive may be mixed by weight percentage. It will thus be appreciated that the resulting additive can be added to water or other base component in any proportion and through any process now known or later developed depending on the context and the preferences of the manufacturer or the consumer in terms of how “strong” or “weak” the resulting beverage or other component is to be. Thus, in the exemplary beverage context, while such formulations and resulting beverages or beverage additives may be based on a typical serving size of approximately 2 tablespoons per 6 ounces cold or hot water, it will be appreciated that a virtually infinite variety of concentrations of the additive relative to water or other such base component of the resulting beverage may be employed without departing from the spirit and scope of the invention. Moreover, any such formulation or composition may be represented or employed based on such serving sizes or for total container weight, such as per one pound bag, for example.

Again, the coffee may be whole bean or ground and of any variety, though for the exemplary formulation, the coffee is in the post-roast state, or has already been roasted in a conventional fashion, as compared to a pre-roast state and a state after actually being brewed or otherwise processed to create a coffee beverage. That is, the formulation entails the mixture of Matcha powder or granules to the coffee beans or grounds before the resulting fortified coffee is then brewed or otherwise processed. The Matcha is “active,” meaning that it is not simply a filler, excipient, binder or the like; hence, the “Total Actives” also being 3.0 grams in the exemplary formulation. The resulting coffee has been found to be flavorful while also being increasingly healthful, it being rich in antioxidants and other physiologically advantageous components due to the inclusion of Matcha alone, as explained above.

Specifically, the coffee beverage according to Example 1 was independently subjected to ORAC (“Oxygen Radical Absorbance Capacity”) analysis to quantify its “total antioxidant capacity” or “TAC.” The ORAC unit of measure was developed in the 1990's by scientists working at or in conjunction with the National Institute on Aging of the National Institutes of Health, Tufts University, and Brunswick Laboratories, and has since been cited by the United States Department of Agriculture in various publications. The ORAC test is further described in Oxygen-Radical Absorbance Capacity for Antioxidants, Cao, G., Free Radical Biol. Med. Vol. 14, (1993); In Vivo Total Antioxidant Capacity: Comparison of Different Analytical Methods, Prior, R. and Cao, G., Free Radical Biol. Med., Vol. 27, Nos. 11/12, pp. 1173-1181 (1999); Total Antioxidant Capacity of Fruits, Wang, H., Cao, G., Prior, R., J. Agric. Food Chem., 44, pp. 701-705 (1996); Antioxidant Capacity of Tea and Common Vegetables, Cao, G., Sofic, E., and Prior, R., J. Agric. Food Chem., 44, pp. 3426-3431 (1996); and U.S. Pat. No. 7,132,296, all of which are incorporated herein in their entirety by this reference. Essentially, ORAC represents the ability of a nutrient to stabilize and neutralize the harmful effects of free radical damage. It has been determined that the human body requires between 3,000 and 5,000 ORAC units per day to functionally counteract the effects of free radicalization. Here, the beverage and beverage additive according to this example tested to an ORACₜₒₜₐₗ (TAC) of 909 μmole TE/g, compared to only about 1 TAC for a generic instant coffee, 13 TAC for grapefruit juice, and about 90 TAC for Sencha green tea, all such values being on the order of +/−15% relative standard deviation due to the accuracy of the testing and measurement process.

Accordingly, it will be appreciated that the addition of Matcha to coffee essentially increases the antioxidant capacity of the resulting beverage by nearly 1,000 times as compared to coffee alone, and by roughly 5 times over even regular brewed, steeped, bagged, loose or bulk green teas alone. Thus, the combination of Matcha with coffee proves to yield a beverage that has significantly increased health benefits over coffee or tea alone, once again, all without sacrificing the flavor of a beverage (coffee) that many people frequently consume several times per day anyway. In that regard, it is further noted that consuming only 3 cups of coffee formulated with a beverage additive according to this example will essentially provide the consumer with nearly the daily recommended number of ORAC units (3,000) without even accounting for any other dietary consumption of antioxidants.

While a particular formulation of coffee plus Matcha is shown and described in Example 1, it will again be appreciated that a number of other combinations or weight ratios of such ingredients may be employed in accordance with aspects of the present invention, as will be further evident from the additional examples that follow. Thus, it is noted that virtually a full range of weight ratios between coffee and Matcha may be employed, depending on the context, such that it is contemplated that formulations according to Example 1, essentially beverages including coffee plus Matcha (or the beverage additive comprising Matcha alone) may range from 10 to 99.9% by weight coffee and from 0.1 to 90% by weight Matcha, or again any form of Matcha or any other form of green tea or any active ingredient or ingredients found in green tea.

### Example 2

In a second exemplary formulation of a beverage or beverage additive according to aspects of the present invention, coffee, Matcha, and now Rooibos are combined by weight ratio according to the following approximate amounts: 12 ounces of coffee, 3.0 grams of Matcha, and 3.0 grams of Rooibos. This formulation entails the mixture of Matcha powder or granules and Rooibos powder or granules to the coffee beans or grounds before the resulting fortified coffee is then brewed or otherwise processed. Both the Matcha and the Rooibos are “active,” again meaning that they are not simply fillers, excipients, binders or the like; hence, here the “Total Actives” are 6.0 grams in this alternative exemplary formulation.

While a particular alternative formulation of coffee plus Matcha and Rooibos is shown and described in this example, it will again be appreciated that a number of other combinations or weight ratios of such ingredients may be employed in accordance with aspects of the present invention. Thus, it is noted once more that virtually a full range of weight ratios between coffee, Matcha and Rooibos may be employed, depending on the context, such that it is contemplated that formulations according to Example 2, essentially beverages including coffee plus Matcha and Rooibos (or the beverage additive comprising Matcha plus Rooibos) may range from 10 to 99.8% by weight coffee, from 0.1 to 89.9% by weight Matcha, or again any form of Matcha or any other form of green tea or any active ingredient or ingredients found in green tea, and from 0.1 to 89.9% by weight green Rooibos, or again any form of Rooibos or any active ingredient or ingredients found in Rooibos.

### Example 3

In a third exemplary formulation of a beverage or beverage additive according to aspects of the present invention, coffee and Rooibos are combined by weight ratio according to the following approximate amounts: 12 ounces of coffee and 3.0 grams of Rooibos. Here, the formulation entails the mixture of Rooibos powder or granules with the coffee beans or grounds before the resulting fortified coffee is then brewed or otherwise processed. The Rooibos is again “active” such that the “Total Actives” are the same 3.0 grams of Rooibos in the alternative exemplary formulation.

While a particular alternative formulation of coffee plus Rooibos is shown and described in connection with this example, it will again be appreciated that a number of other combinations or weight ratios of such ingredients may be employed in accordance with aspects of the present invention. Thus, it is noted once more that virtually a full range of weight ratios between coffee and Rooibos may be employed, depending on the context, such that it is contemplated that formulations according to Example 3, essentially beverages including coffee plus Rooibos (or the beverage additive comprising Rooibos alone) may range from 10 to 99.9% by weight coffee, and from 0.1 to 90% by weight green Rooibos, or again any form of Rooibos or any active ingredient or ingredients found in Rooibos.

### Example 4

In a fourth exemplary formulation of a beverage or beverage additive according to aspects of the present invention, coffee and Matcha are combined by weight ratio according to the following approximate amounts: 5 grams of coffee and 0.3 grams of Matcha. Here, the formulation involves a relatively higher concentration of Matcha relative to coffee as compared to the exemplary formulation in Example 1, resulting in a so-called “black tea” beverage, or a coffee beverage that substantially looks and tastes like black tea yet with a total antioxidant capacity roughly 10 times that of even a green tea. Once more, the formulation entails the mixture of Matcha powder or granules to the coffee beans or grounds before the resulting fortified coffee is then brewed or otherwise processed. The Matcha is again “active” such that the “Total Actives” are 0.3 grams in this alternative exemplary formulation. As with the discussion above regarding the first exemplary formulation, it will again be appreciated that a number of other combinations or weight ratios of at least the coffee and Matcha ingredients may be employed in accordance with aspects of the present invention covering virtually a full range of weight ratios between coffee and Matcha, depending on the context.

### Example 5

In a fifth exemplary formulation of a beverage or beverage additive according to aspects of the present invention, Matcha and Rooibos are combined by weight ratio according to the following approximate amounts: 5 grams of Rooibos and 0.3 grams of Matcha. Here, the formulation involves an instant or fusion tea combination of Rooibos and Matcha based on a serving size of approximately 1 teaspoon of combined actives per 8 ounces cold or hot water. Again, other serving sizes are possible, as well as proportions based on total container weight, for example, such that the above serving size is to be understood as merely exemplary. The resulting tea is again expected to have an ORAC value or total antioxidant capacity several times that of green tea. In this alternative embodiment, the formulation entails the mixture of Rooibos powder or granules and Matcha powder or granules together and then mixing, brewing or steeping the tea in any fashion, whether with hot or cold water and utilizing any equipment or method now know or later developed. In this “fusion tea” beverage, both the Rooibos and Matcha are again “active” such that the “Total Actives” here are 5.3 grams.

As with the discussion above regarding the first exemplary formulation, it will again be appreciated that a number of other combinations or weight ratios of the Rooibos and Matcha ingredients may be employed in accordance with aspects of the present invention covering virtually a full range of weight ratios between Rooibos and Matcha, depending on the context. Specifically, it is contemplated that formulations according to Example 5, essentially tea beverages including Matcha and Rooibos (or the beverage additive comprising Matcha plus Rooibos) may range from 0.1 to 99.9% by weight green Rooibos, or again any form of Rooibos or any active ingredient or ingredients found in Rooibos, and from 0.1 to 99.9% by weight Matcha, or again any form of Matcha or any other form of green tea or any active ingredient or ingredients found in green tea.

Based on the foregoing, it will be appreciated by those skilled in the art that a variety of beverages or beverage additives can be formed or formulated according to aspects of the present invention by combining just Matcha and/or Rooibos alone or with a base component or ingredient such as coffee, once more as whole beans or grounds, to produce a variety of flavorful “fusion” beverages that are quite high in antioxidants and other healthful benefits. Accordingly, it will be further appreciated that, depending on the components such as Matcha and Rooibos and other adjuncts being combined and the ultimate beverage to be created, a number of possibilities exist for how and when such components are brought together. As explained above and illustrated through the various exemplary embodiments, one “fusion” process entails the addition or admixing of Matcha and/or Rooibos in its or their raw powder form together or to whole bean or ground coffee, the resulting fortified composition then being processed accordingly as through a brewing or steeping process. As an alternative embodiment, a powder composition or the like of Matcha and/or Rooibos, alone or in further combination with other adjuncts as further set forth below, may simply be added to or admixed with an already brewed, steeped or otherwise prepared beverage, again, just as one would add cream or sugar to a cup of coffee. In this regard, those skilled in the art will further appreciate the virtually infinite possibilities for an additive according to aspects of the present invention, which could in fact be added to most any consumable to fortify or enrich such food or beverage, particularly with antioxidants or “total antioxidant capacity.” More particularly, continuing with the exemplary coffee context, it is contemplated that dairy or non-dairy creamers and powders could be fortified with Matcha and/or Rooibos according to aspects of the present invention to provide an antioxidant enriched coffee additive that otherwise does not negatively affect the flavor of the additive and hence the resulting cup or pot of coffee. Or, such a super-antioxidant powder can be provided alone, or apart from any creamer or the like, and simply added to a beverage or other product to boost its healthfulness.

### Example 6

Following from the foregoing discussion, in a sixth exemplary formulation of a beverage or beverage additive according to aspects of the present invention, Matcha and Rooibos are combined by weight ratio according to the following approximate amounts: 20 grams of Rooibos and 1 gram of Matcha. In this formulation, a super-antioxidant powder as a beverage or other product additive is derived from the combination of Rooibos and Matcha. In the exemplary embodiment, both the Rooibos and Matcha are once again “active” such that the “Total Actives” here are 21 grams. With a formulation based on an exemplary additive serving size of approximately 1 teaspoon of combined actives to any dilution strength desired, it will be appreciated that, by comparison to the exemplary embodiment of Example 5 and the typical 8 ounces for the base, such as water, of the beverage or other product itself, the super-antioxidant powder according to Example 6 is indeed packed with even more antioxidants per serving or usage.

As above with the other exemplary beverages or beverage additives, it will again be appreciated that a number of other serving sizes and combinations or weight ratios of the Rooibos and Matcha ingredients beyond that shown in this example may be employed in accordance with aspects of the present invention covering virtually a full range of weight ratios between Rooibos and Matcha, depending on the context. Specifically, it is contemplated that formulations according to Example 6, essentially beverage additives including Matcha and Rooibos, may range from 0.1 to 99.9% by weight green Rooibos, or again any form of Rooibos or any active ingredient or ingredients found in Rooibos, and from 0.1 to 99.9% by weight Matcha, or again any form of Matcha or any other form of green tea or any active ingredient or ingredients found in green tea.

Moreover, it will be further appreciated that while the super-antioxidant powder is described in the context of beverages and beverage additives, it can also be added in a virtually infinite variety of proportions to other food, health and skin care, and other such products without departing from the spirit and scope of the invention, the advantages of the combination of Matcha and Rooibos in most any relative concentration by weight percent being transferable to or realized in products other than beverages and beverage additives.

### Example 7

In a further exemplary formulation of a beverage or beverage additive according to aspects of the present invention, coffee, Matcha, green Rooibos, and now freeze-dried Goji Berries are combined by weight ratio according to the following approximate amounts: 9-11 ounces of coffee, 3.0 grams of Matcha, 3.0 grams of Rooibos, and 1-3 ounces of Goji Berries. This formulation entails the mixture of Matcha powder or granules, Rooibos powder or granules, and freeze-dried Goji Berries, whether whole or in powder form, to the coffee beans or grounds before the resulting fortified coffee is then brewed or otherwise processed.

While a particular alternative formulation of coffee plus Matcha, Rooibos and Goji Berries is shown and described in connection with Example 7, it will again be appreciated that a number of other combinations or weight ratios of such ingredients may be employed in accordance with aspects of the present invention. Thus, it is noted once more that virtually a full range of weight ratios between coffee, Matcha, Rooibos, and Goji Berries may be employed, depending on the context, such that it is contemplated that formulations according to Example 7, essentially beverages including coffee plus Matcha, Rooibos, and Goji Berries (or the beverage additive comprising Matcha plus Rooibos plus Goji Berries) may range from 10 to 99.7% by weight coffee, from 0.1 to 89.8% by weight Matcha, or again any form of Matcha or any other form of green tea or any active ingredient or ingredients found in green tea, from 0.1 to 89.8% by weight green Rooibos, or again any form of Rooibos or any active ingredient or ingredients found in Rooibos, and from 0.1 to 89.8% by weight Goji Berries, or any form of Goji or any active ingredients found in Goji.

Other adjuncts that may be combined in various ways and contexts, and in any and all forms, to a base beverage, beverage additive, or other product, including at least Matcha, Rooibos and/or Goji Berry, include açai (Euterpe oleracea), blueberry (Vaccinium angustifolium and Vaccinium corymbosum), cranberry (Vaccinium macrocarpon), grape (red, Vitis vinifera), guarana (Paullinia cupana), mangosteen (Garcinia mangostana), noni (Morinda citrifolia), pomegranate (Punica granatum), sea-buckthorn (Hippophae rhamnoides), strawberries (Fragaria vesca), red raspberries (Rubus idaeus), blackberries (Rubus ursinus), acerola (Barbados cherry, Malpighia emarginata, Malpighia glabra), baobab (Adansonia digitata), red bayberry (yumberry, Myrica rubra), bilberry (Vaccinium myrtillus), black raspberry (Rubus occidentalis), black chokeberry (“aronia”, Aronia melanocarpa), blackcurrant (Ribes nigrum), camu camu (Myrciaria dubia), sour (tart) cherry (Prunus cerasus), cupuaçu (Theobroma grandiflorum), durian (Durio kutejensis), elderberry (Sambucus canadensis, Sambucus nigra), red guava (Psidium guajava, many species), Indian gooseberry (amalaka, amla, Phyllanthus emblica), kiwifruit (Actinidia deliciosa), lingonberry (Vaccinium vitis-idaea), longan (Dimocarpus longan), lychee (Litchi chinensis), mango (Mangifera indica), muscadine grape (Vitis rotundifolia), papaya (Carica papaya), saskatoon berry (Amelanchier alnifolia, Nutt), tamarind (Tamarindus indica), wild cherry (sweet, Prunus avium), yuzu (Citrus ichangensis x C. reticulata), Chia Seed (Salvia hispanica), Rambutan (Nephelium lappaceum), Cacao, (Theobroma cacao), Coffee Berry raw (Coffea arabica), Bee Pollen, Aloe Vera (A. barbadensis Mill., Aloe indica Royle, Aloe perfoliata L. var. vera and A. vulgaris Lam), Yacon Root (Smallanthus sonchifolius), Synonyms (Polymnia sonchifolia), Maca (Lepidium meyenii), Rose hips (Rosa canina) (Dog Rose) and (R. majalis), Watercress (Nasturtium officinale, N. microphyllum; formerly Rorippa nasturtium-aquaticum, R. microphylla), Papaya (Carica papaya), Soy (Glycine max), Flax seed (Linum usitatissimum), Oranges Citrus sinensis (syn. Citrus aurantium L. var. dulcis L., or Citrus aurantium Risso), Walnuts (family Juglandaceae all) (Genus Juglans), Honey, Quinoa (Chenopodium quinoa), Hazel Nuts (Corylus avellana), Vanilla Bean (Vanilla planifolia, V. planifolia, syn. V. fragrans, V. tahitensis, and V. pompona), Caramel, Butterscotch, apple (Malus domestica), sceletium tortuosum (Kanna), water avens (Geum rivale), cleavers goose grass (Gallium Aparine), scotch broom (Cytisus scoparius), common sunflower (Helianthus annuus), chufa (Cyperus esculentus), beech (Fagus grandifolia), kentucky coffee tree (Gymnocladus dioica), feverwort (Triosteum perfoliatum), and yaupon, cassina (Ilex vomitoria). Those skilled in the art will appreciate that the foregoing list is non-exhaustive and that these and a number of other naturally occurring adjuncts may in some form be incorporated into a beverage or beverage additive or other product according to aspects of the present invention for a variety of purposes, such that those adjuncts listed are to be understood as being merely illustrative.

To summarize, regarding the exemplary beverage or beverage additive of the present invention as described above in connection with coffees and teas, it will be appreciated that a composition of at least Matcha and/or Rooibos and/or Goji Berry is disclosed that may then be added to or admixed with the underlying beverage or base components of such beverage to yield a resulting beverage that is both flavorful and high in antioxidants and other healthful benefits. Because the principles of the invention may be practiced in a number of configurations of the various beverage additives beyond those described, it is to be understood that the invention is not in any way limited by the exemplary embodiments, but is generally directed to some combination of at least Matcha and/or Rooibos and/or Goji Berry with an underlying beverage constituent, other food, health care or skin product, and/or other adjunct and so is able to take numerous forms without departing from the spirit and scope of the invention.

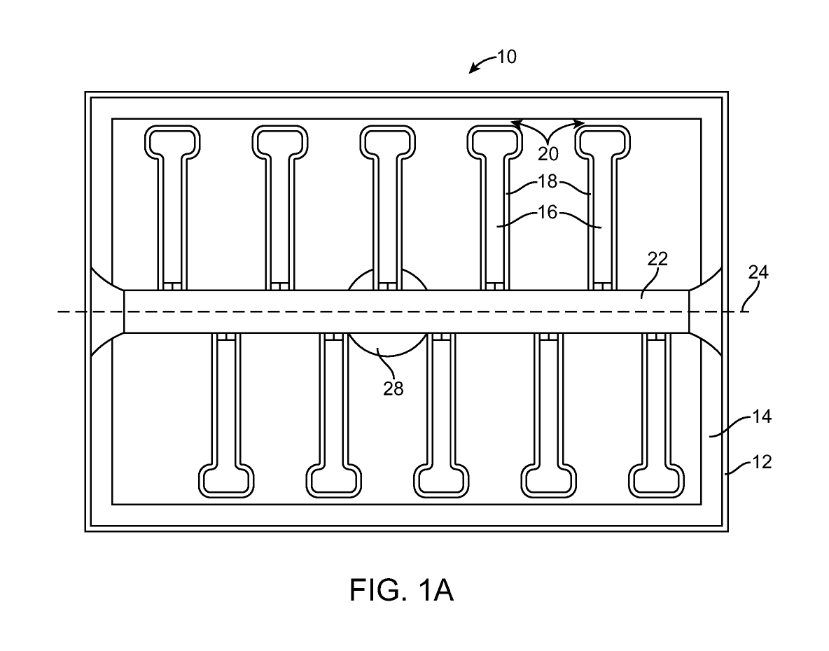

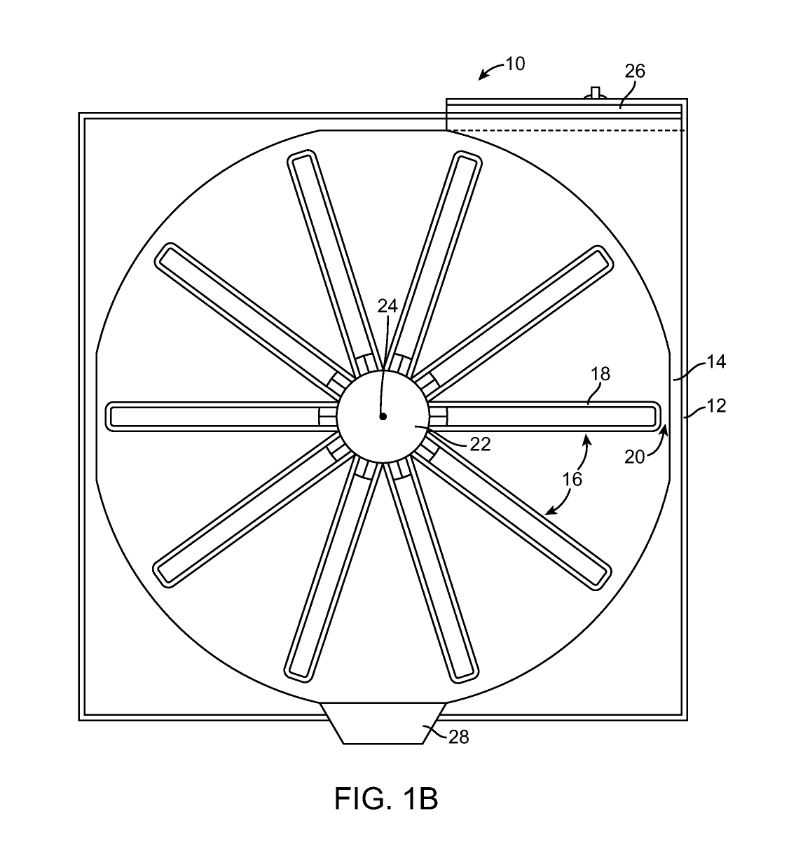

In another embodiment, a fused antioxidant additive comprises at least two of Matcha, Rooibos, and/or Goji Berry. The fused antioxidant additive is different from the additive described above in that the fused antioxidant additive includes at least two components that are fused to one another in a fusion process that is carried out in a specially-designed fusion chamber 10, shown in FIGS. 1A and 1B. Generally, the fusion chamber 10 includes an outer container 12, a liner 14 on the inner surface of the container 12, and rotatable paddles 16 within the container 12. The fusion chamber 10 further includes an entry port 26 through which the ingredients are added to the fusion chamber 10, and an exit port 28 through which the finished product (i.e., the fused antioxidant additive) is removed from the fusion chamber 10.

The container 12 may be formed of a conductive material, e.g., steel, and may have a rectangular shape. For example, the container 12 may have a length of about 10 to 12 feet, a width of about 5 to 7 feet, and a height of about 5 to 7 feet. Alternatively, the container 12 may be cylindrical (not shown).

The rotating paddles 16 may also be formed of a conductive material, e.g., steel, and may include sleeves 18 that cover the outer surface of the conductive material. The fusion chamber 10 shown in FIGS. 1A and 1B includes ten sets of five paddles 16 (not all of the paddles are shown) in a staggered arrangement that are each about 24 inches long, about 3 inches wide not including the sleeves 18, and about 5 inches wide including the sleeves 18. The paddles 16 are connected to a central hub 22 in the center of the container 12, and extend perpendicularly therefrom. As the central hub 22 rotates about the central axis 24, the paddles 16 rotate within the container 12 around the central axis 24.

The liner 14 on the inner surface of the container 12 may have a square-shaped outer circumference and a generally circular inner circumference, as shown in FIG. 1B. Alternatively, if the outer container is cylindrical, the liner 14 may have a constant thickness. For example, the liner 14 may be about 2 inches thick.

The material of the liner 14 and the material of the paddle sleeves 18 are on opposite ends of a triboelectric series. For example, the material of the liner 14 may be a material that is more likely to attain a negative charge, e.g., hard rubber, polyurethane, vinyl, Teflon, etc., and the material of the paddle sleeves 18 may be a material that is more likely to attain a positive charge, e.g., nylon, wool, silk, leather, etc., or vice versa. A gap 20 between the distal ends of the paddle sleeves 18 and the inner surface of the liner 14 may be adjusted, depending on the desired amount of charge transfer. In one exemplary embodiment, the gap 20 is about 0.25 inches.

It should be well understood that the measurements, materials, and arrangements described above in connection with the fusion chamber 10 are merely for exemplary purposes and that many other possible measurements, materials, and arrangements are contemplated and are within the scope of this invention.

In a method of making the fused antioxidant additive, with the exit port 28 sealed, desired amounts of at least two powdered components (e.g., powdered Matcha and powdered Rooibos, powdered Matcha and powdered Goji Berry, powdered Rooibos and powdered Goji Berry, or powdered Matcha, powdered Rooibos, and powdered Goji Berry) are added to the fusion chamber 10 through the entry port 26. The port 26 is then closed and the paddles 16 are rotated, e.g., at a rate of between about 900 and 1100 RPMs around central axis 24. Due to the triboelectric effect and the charge exchanged between the paddle sleeves 18 and the liner 14 during paddle rotation, charge builds up in the powdered components, thus causing the powdered components to bind, or “fuse,” to each other. Sufficient fusion between the powdered components occurs after the paddles 16 have been rotating for a suitable amount of time, e.g., about 10 minutes, which may be predetermined. The resulting fused antioxidant additive is water-soluble and fat-soluble.

In order to verify that a desired amount of fusion between the two or more components has occurred, the fused antioxidant additive may be subjected to one or more verification tests. For example, one verification test may include inserting an elongated testing member (i.e., a “dip stick”) into the fused antioxidant additive, the dip stick being formed of a material substantially similar to that used to form the paddle sleeves 18, and observing the amount of fused antioxidant additive that clings to the dip stick when the dip stick is removed from the fused antioxidant additive. If the dip stick is completely and evenly covered with the fused antioxidant additive upon removal, then it is verified that the fusion process is complete. However, if the dip stick is only sporadically covered and/or is unevenly covered, then the fusion process should be continued.

Another exemplary verification process involves weighing a given volume of the fused antioxidant additive. Surprisingly and unexpectedly, it has been found that the fused antioxidant additive has a significantly greater density than a mixture of the individual powdered components. That is, a given volume of the fused antioxidant additive weighs more than a mixture of the individual powdered components of the same volume that have not been subjected to the fusion process. For example, a gallon bucket full of Matcha powder and Rooibos powder weighs less, e.g., about 50% less, than a gallon bucket full of fused antioxidant additive that is made from Matcha powder and Rooibos powder. Thus, in this exemplary verification process, a given volume of the fused antioxidant additive is weighed and, if the weight of the given volume has increased by a certain measureable amount over the weight of the given volume of the individual components, then it is verified that the fusion process is complete. However, if the weight of the given volume has not increased by the amount (which may be predetermined), then the fusion process should be continued.

Similarly, the fusion process can be verified by visually ascertaining whether the volume of the contents of the fusion chamber 10 has decreased by a certain measureable amount. For example, the powdered additive starting ingredients (e.g., Matcha powder, Rooibos powder, and/or Goji Berry powder) may be added to the fusion chamber 10 up to a marked “starting” fill line. After running the fusion chamber 10 (i.e., rotating the paddles 16) for a while, the fusion chamber 10 is turned off (i.e., the paddle rotation is halted) and, if the volume of the contents of the fusion chamber 10 has decreased to a marked “finish” fill line, where the “finish” line may, for example, represent a volume at which the density of the chamber contents has increased by about 50%, then it is verified that the fusion process is complete. However, if the volume of the contents of the fusion chamber 10 is still above the marked “finish” line, then the fusion process should be continued.

### Example 8

In an eighth exemplary formulation, a fused antioxidant additive is formed by adding Matcha powder and Rooibos extract powder to the fusion chamber 10 in a weight ratio of Matcha to Rooibos of about 1 to 3 (e.g., 1 gram of Matcha powder per 3 grams of Rooibos powder). The paddles 16 in the fusion chamber 10 are rotated at a rate of about 1,000 RPM for about 10 minutes to form a fused antioxidant additive consisting of Matcha and Rooibos. The fused antioxidant additive of this example can be added to beverages, food, skin care products, etc., as discussed above. In addition, due to its unique properties, the fused antioxidant additive is able to withstand temperatures as high as 450° F. and as low as 30° F. without decomposing, i.e., the fused antioxidant additive is stable at temperatures between 30° F. and 450° F. Thus, the fused antioxidant additive can advantageously be added to coffee beans during the coffee roasting process, which is discussed in greater detail below.

While a particular formulation of fused Matcha and Rooibos is shown and described in connection with this example, it will again be appreciated that a number of other combinations or weight ratios of such ingredients may be employed in accordance with aspects of the present invention. Thus, it is noted once more that virtually a full range of weight ratios between Matcha and Rooibos may be employed, depending on the context, such that it is contemplated that formulations according to Example 8, essentially fused antioxidant additives including Matcha plus Rooibos may range from 20 to 80% by weight of Matcha, and from 20 to 80% by weight of Rooibos.

### Example 9

In a ninth exemplary formulation, a fused antioxidant additive is formed by adding Matcha powder, Rooibos extract powder, and powdered Goji Berry to the fusion chamber 10 in a weight ratio of Matcha to Rooibos to Goji Berry of about 1 to 1 to 3 (e.g., 1 gram each of Matcha powder and Rooibos powder per 3 grams of Goji Berry powder). The paddles 16 in the fusion chamber 10 are rotated at a rate of about 1000 RPMs for about 10 minutes to form a fused antioxidant additive consisting of Matcha, Rooibos, and Goji Berry. Similar to Example 8, the fused antioxidant additive of this example can be added to beverages, food, skin care products, etc, as discussed above. In addition, the fused antioxidant additive can be added to coffee beans during the roasting process, which is discussed in greater detail below.

While a particular formulation of Matcha, Rooibos, and Goji Berry is shown and described in connection with this example, it will again be appreciated that a number of other combinations or weight ratios of such ingredients may be employed in accordance with aspects of the present invention. Thus, it is noted once more that virtually a full range of weight ratios between Matcha, Rooibos, and Goji Berry may be employed, depending on the context, such that it is contemplated that formulations according to Example 9, essentially fused antioxidant additives including Matcha plus Rooibos plus Goji Berry may range from 10 to 80% by weight of Matcha, from 10 to 80% by weight of Rooibos, and from 10 to 80% by weight of Goji Berry.

One advantage of the fused antioxidant additive is that it may be added to coffee beans during the roasting process. Typical coffee additives cannot be added during the roasting process, because the high temperatures used in coffee roasting causes such additives to break down, degrade, and/or otherwise decompose. In contrast, the fused antioxidant additive can tolerate such high temperatures (e.g., up to 450° F.) without decomposing. In fact, it is hypothesized that the high temperatures used during coffee roasting may increase the antioxidant effects of the fused antioxidant additive.

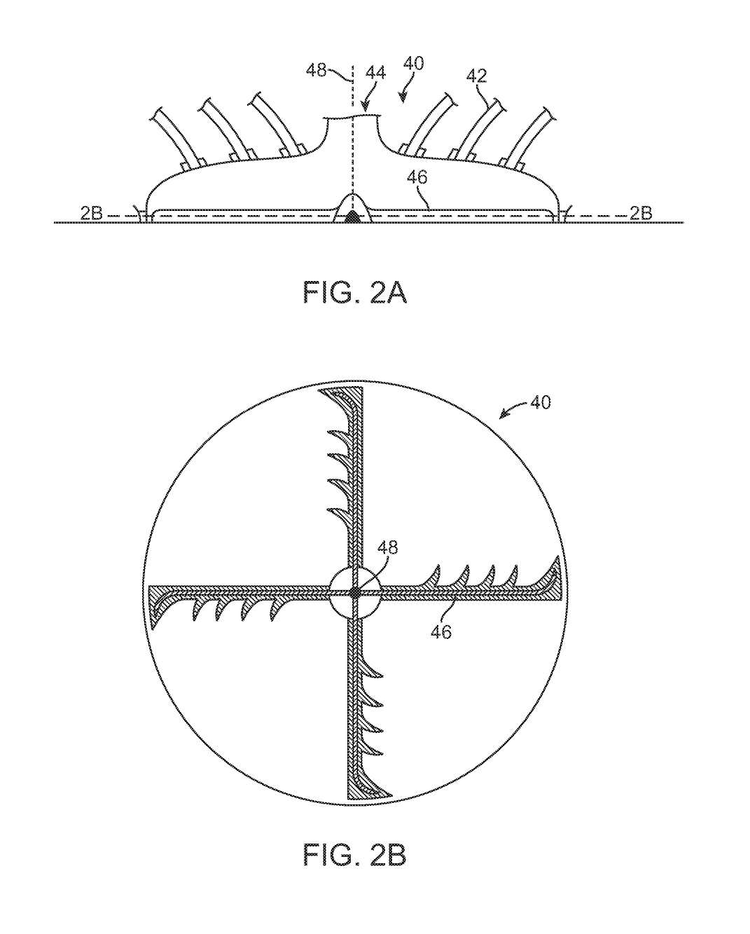

In one embodiment, coffee roasting is performed in a modified roasting chamber 40, shown in FIGS. 2A and 2B, that includes inlets 42 for adding the fused antioxidant additive to the coffee beans during roasting. The inlets 42 are insulated so that heat from the roasting chamber 40 does not escape through the inlets 42. The roasting chamber 40 also includes a central chute 44 through which green, unroasted coffee beans are added into the roasting chamber 40. Paddles 46 positioned in the bottom of the chamber 40 around a central axis 48 rotate to stir the beans during the roasting process.

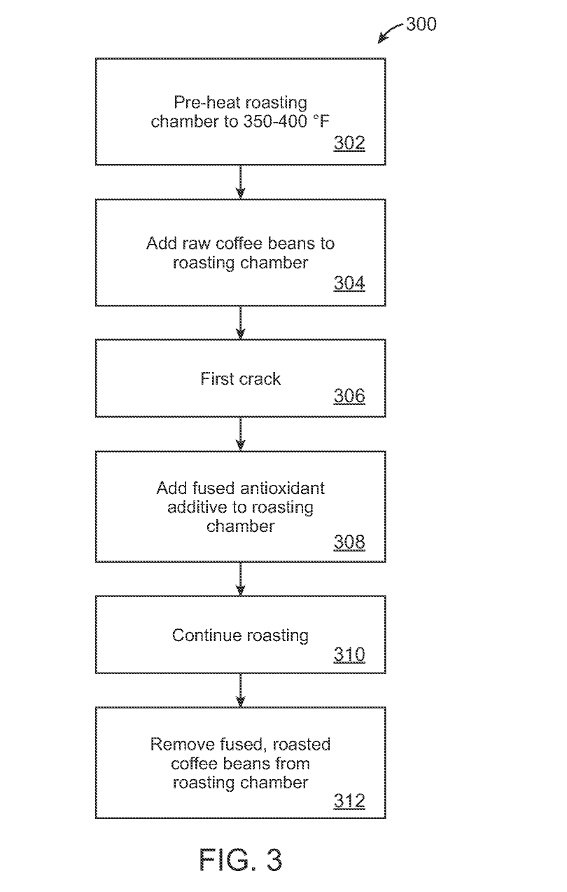

The roasting process 300 is described in more detail with reference to FIG. 3. First, in step 302, the roasting chamber 40 is pre-heated to about 350-400° F. Next, in step 304, whole green coffee beans are added to the pre-heated roasting chamber 40. The temperature of the roasting chamber 40 is maintained and the paddles 46 are rotated for about 6-10 minutes until the “first crack” stage of roasting occurs, in step 306. After first crack, the fused antioxidant additive is added to the roasting chamber 40 through the inlets 42 in step 308. Roasting is continued, in step 310, until the desired depth of roast has been achieved, e.g., for about 20-25 more minutes, with a lighter roast requiring a shorter roasting duration, and a darker roast requiring a longer roasting duration. When the coffee beans have been roasted to a desired depth of roast, the roasting is halted and the roasted, fused coffee beans are removed from the chamber 40 in step 312 and allowed to cool and degas prior to grinding and/or packaging.

Coffee roasted in this manner was found to have an unexpectedly high ORAC value. In particular, when the fused antioxidant additive is added to the coffee beans during roasting, the resulting roasted coffee has been found to have an ORAC value of about 7,218 TAC, compared to 909 TAC for the additive formulated according to Example 1. The inventor theorizes that there is an undiscovered reaction occurring during roasting wherein the fused antioxidant additive fuses to the coffee beans, thereby creating additional antioxidant molecules.

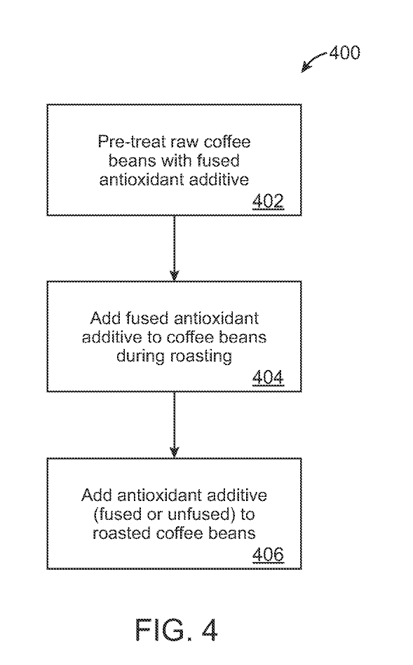

The fused antioxidant additive may be added to coffee before, during, and/or after roasting. A flow chart of the method 400 for incorporating the antioxidant additive to coffee is shown in FIG. 4. First, green, unroasted coffee beans may optionally be pre-treated with the fused antioxidant additive in step 402. This pre-treatment step may include exposing the green, unroasted beans to a liquid form of the fused antioxidant additive, e.g., by spray coating, immersing, or the like. The liquid form of the fused antioxidant additive may be made by dissolving the powdered form of the fused antioxidant additive in a solvent, e.g., water, alcohol, propylene glycol, etc. The green coffee beans are then dried by heating until a desired moisture content, e.g., about 10-14%, has been reached. This pre-treatment step using the fused antioxidant additive may prevent certain degradations from occurring during roasting. In this manner, a lower grade coffee bean, e.g., Robusta, that has been pre-treated with the fused antioxidant additive and then roasted may result in a coffee product similar in quality to that of a higher grade bean, e.g., Arabica.

Next, the raw coffee beans are roasted in step 404. The fused antioxidant additive may be added during the roasting process, as described in greater detail above. Then, the antioxidant additive, in the fused or unfused form, may be added to the roasted beans or coffee grounds in step 406. It should be well understood that any combination of one, two, or all three of steps 402, 404 and 406 may be performed.

Although particular embodiments of the present invention have been shown and described, it will be understood that it is not intended to limit the present invention to the preferred embodiments, and it will be apparent to those skilled in the art that various changes and modifications may be made without departing from the spirit and scope of the present invention. Thus, the present invention is intended to cover alternatives, modifications, and equivalents, which may be included within the spirit and scope of the present invention as defined by the claims.

1. A powdered, water-soluble and fat-soluble, antioxidant additive, comprising:
at least two components selected from the group consisting of: Matcha, Rooibos, and Goji Berry,
wherein the at least two components are fused to one another, and
wherein a heat stability of the additive is such that the additive is capable of being incorporated into coffee beans during a roasting process.

2. A method for making a fused antioxidant additive, the method comprising:
adding at least two powdered components to a fusion chamber, wherein the at least two powdered components are selected from the group consisting of Matcha, Rooibos, and Goji Berry, wherein the fusion chamber comprises an inner lining, rotatable paddles, and sleeves covering the paddles, and wherein a material of the inner lining and a material of the paddle sleeves are on opposite ends of a triboelectric series;
rotating the paddles in the fusion chamber; and
verifying that the at least two components have transformed into the fused antioxidant additive.

3. An antioxidant additive comprising Matcha and Rooibos.

4. The additive of claim 3, wherein the Matcha and Rooibos are subjected to a fusion process, such that the additive is a fused additive.

5. The additive of claim 3, wherein the additive is a water-soluble and fat-soluble powder.

6. The additive of claim 5, wherein the additive further comprises Goji Berry.

7. The additive of claim 3, wherein a heat stability of the additive is such that the additive is capable of being incorporated into coffee beans during a roasting process.

8. The additive of claim 3, wherein the additive is stable at temperatures between about 300 and 450 degrees Fahrenheit.

9. The additive of claim 3, wherein the additive consists of Matcha and Rooibos.

10. The additive of claim 3, further comprising another component selected from the group consisting of: açai (Euterpe oleracea), blueberry (Vaccinium angustifolium and Vaccinium corymbosum), cranberry (Vaccinium macrocarpon), grape (red, Vitis vinifera), guarana (Paullinia cupana), mangosteen (Garcinia mangostana), noni (Morinda citrifolia), pomegranate (Punica granatum), sea-buckthorn (Hippophae rhamnoides), strawberries (Fragaria vesca), red raspberries (Rubus idaeus), blackberries (Rubus ursinus), acerola (Barbados cherry, Malpighia emarginata, Malpighia glabra), baobab (Adansonia digitata), red bayberry (yumberry, Myrica rubra), bilberry (Vaccinium myrtillus), black raspberry (Rubus occidentalis), black chokeberry (“aronia”, Aronia melanocarpa), black currant (Ribes nigrum), camu camu (Myrciaria dubia), sour (tart) cherry (Prunus cerasus), cupuaçu (Theobroma grandiflorum), durian (Durio kutejensis), elderberry (Sambucus canadensis, Sambucus nigra), red guava (Psidium guajava, many species), Indian gooseberry (amalaka, amla, Phyllanthus emblica), kiwifruit (Actinidia deliciosa), lingonberry (Vaccinium vitis-idaea), longan (Dimocarpus longan), lychee (Litchi chinensis), mango (Mangifera indica), muscadine grape (Vitis rotundifolia), papaya (Carica papaya), saskatoon berry (Amelanchier alnifolia, Nutt), tamarind (Tamarindus indica), wild cherry (sweet, Prunus avium), yuzu (Citrus ichangensis x C. reticulata), chia seed (Salvia hispanica), rambutan (Nephelium lappaceum), cacao, (Theobroma cacao), coffee berry raw (Coffea arabica), bee Pollen, aloe vera (A. barbadensis Mill., Aloe indica Royle, Aloe perfoliata L. var. vera and A. vulgaris Lam), yacon root (Smallanthus sonchifolius), synonyms (Polymnia sonchifolia), maca (Lepidium meyenii), Rose hips (Rosa canina, Dog Rose, and R. majalis), watercress (Nasturtium officinale, N. microphyllum; formerly Rorippa nasturtium-aquaticum, R. microphylla), papaya (Carica papaya), soy (Glycine max), flax seed (Linum usitatissimum), oranges citrus sinensis (syn. Citrus aurantium L. var. dulcis L., or Citrus aurantium Risso), walnuts (family Juglandaceae all) (Genus Juglans), honey, quinoa (Chenopodium quinoa), hazel nuts (Corylus avellana), vanilla bean (Vanilla planifolia, V. planifolia, syn. V. fragrans, V. tahitensis, and V. pompona), caramel, butterscotch, apple (Malus domestica), sceletium tortuosum (Kanna), water avens (Geum rivale), cleavers goose grass (Gallium Aparine), scotch broom (Cytisus scoparius), common sunflower (Helianthus annuus), chufa (Cyperus esculentus), beech (Fagus grandifolia), kentucky coffee tree (Gymnocladus dioica), feverwort (Triosteum perfoliatum), and yaupon, cassina (Ilex vomitoria).

11. A method for making a fused additive, the method comprising:
adding at least two powdered components to a fusion chamber, the chamber comprising an inner lining, rotatable paddles, and sleeves covering the paddles, wherein a material of the inner lining and a material of the paddle sleeves are on opposite ends of a triboelectric series; and
rotating the paddles in the fusion chamber until a volume of the contents of the fusion chamber has decreased by a selected amount.

12. The method of claim 11, wherein the at least two powdered components comprise Matcha and Rooibos.

13. The method of claim 11, wherein the at least two powdered components comprise Matcha, Rooibos, and Goji Berry.

14. The method of claim 11, wherein the step of rotating the paddles comprises rotating the paddles at a rate of between about 900 and 1100 RPMs.

15. A method for fusing an additive to coffee beans during roasting, the method comprising:
adding raw coffee beans to a pre-heated roasting chamber;
roasting the coffee beans until first crack;
after first crack, adding the additive to the roasting chamber, wherein the additive comprises at least two components fused together, and wherein the at least two components are selected from the group consisting of: Matcha, Rooibos, and Goji Berry; and
roasting the coffee beans until the additive is incorporated into the coffee beans, and a desired roast depth is achieved.

16. The method of claim 15, further comprising pre-treating the raw coffee beans with the additive.

17. The method of claim 15, further comprising, before adding the additive to the roasting chamber, fusing together the at least two components using a fusion process.

18. The method of claim 15, wherein the additive comprises Matcha and Rooibos.

19. The method of claim 18, wherein the additive comprises Matcha Rooibos, and Goji Berry.

20. (canceled)

21. The method of claim 2, wherein the verifying comprises visually ascertaining that the volume of the components in the fusion chamber has decreased by a predetermined amount.
